(19) United States
(12) Patent Application Publication
(10) Pub. No.: US 2004/0032868 A1
(43) Pub. Date: Feb. 19, 2004

(54) LAN switching method and LAN switch

(76) Inventors: Sotaro Oda, Fukuoka (JP); Atsushi Kitada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/615,720

(22) Filed: Jul. 8, 2003

(30) Foreign Application Priority Data
Aug. 16, 2002 (JP) 2002-237247

(51) Int. Cl. H04L 12/56; H04L 12/28

(52) U.S. Cl. 370/389

(57) ABSTRACT

In a LAN switch capable of recognizing a VLAN, a plurality of paths are associated with a VLAN having a plurality of same members as components, and frames from the members are mapped to a predetermined path selected from among the paths. Also, a plurality of different VLAN's are associated with a single group composed of a plurality of members, and frames from the members are mapped to a predetermined VLAN selected from among the VLAN's. Furthermore, information of a frame is associated with the group to which a member having transmitted the frame belongs, and the received frame is mapped to the group to which the member having transmitted the frame belongs, based on the information of the frame.

### BACKGROUND OF THE INVENTION

1. Field of the Invention

The present invention relates to a LAN (Local Area Network) switch, and in particular to a LAN switch capable of recognizing a Virtual LAN (hereinafter, abbreviated as VLAN).

Recently, together with developments of communication technology, the speed of a LAN has been enhanced so that a LAN with a speed in the order of Gbps has been realized. Also, as a bridge connecting LAN's, a LAN switch of layer 2 has been remarkable and has become widely available. On such a high-speed LAN switch, its service quality has become more and more important.

2. Description of the Related Art

FIG. 26 shows an example of an Ethernet network 500 defined by IEEE 802.3 using a LAN switch.

The network 500 is composed of a LAN switch 100a to which a user terminal 300a is connected with a link 400a, a LAN switch 100c to which a user terminal 300b is connected with a link 400e, and a LAN switch 10b. The switches 100a, 100b, and 100c are connected in this order with links 400b, 400c, and 400d to form a loop.

When no measures are taken against the loop on the network path, the switches 100a-100c keep transferring frames around the loop, thereby adversely affecting other traffics.

As measures against the loop, many L2 (layer 2) switches mount thereon a spanning tree protocol (hereinafter, abbreviated as STP), which is for detecting a loop portion on a network path and making it a standby mode.

Namely, the STP enables the L2 switches to mutually transmit/receive control information called BPDU (Bridge Protocol Data Unit) based on a priority provided to the L2 switches.

By exchanging this control information, the STP establishes only one loopless topology (spanning tree), normally transmits frames by using a link included in this topology, and establishes other links as a detour path upon fault.

FIG. 27 shows a case where the STP is introduced to the network shown in FIG. 26. The frame transmitted/received between the user terminals 300a and 300b is normally transmitted through the links 400a, 400b, 400c, and 400e (shown by thick lines), while the link 400d (shown by a thin line) is used as a detour path upon fault.

Thus, even if a network is physically looped, it can prevent a frame from continuing to go around the loop.

When a fault has occurred in the link 400b for example, the STP establishes a spanning tree not using the link 400b. However, it takes a certain time to establish the spanning tree.

A Rapid Spanning Tree Protocol (hereinafter, abbreviated as RSTP) rapidly establishes a spanning tree without links unavailable when a fault has occurred, which is widely adopted.

However, in either case of the STP or the RSTP, the link 400b is not used in the normal time when no fault occurs.

Accordingly, a multiple spanning tree protocol (hereinafter, abbreviated as MSTP) has been developed, which is mounted on many L2 switches. When a plurality of VLAN's such as a VLAN 1 associated with the terminals 300a and 300b, and a VLAN 2 associated with terminals 300c, 300d, and 300e (not shown) are established over the network, the MSTP establishes a spanning tree for each VLAN on an RSTP basis.

At the time of this establishment, the MSTP uses a link, which has not been used in the spanning tree associated with e.g. the VLAN 1, in the spanning tree associated with the VLAN 2. Thus, it becomes possible for the MSTP to provide a redundancy function and a load distribution function.

The L2 switch is of a VLAN recognition type and has been able to classify traffic, whereby the technology of the MSTP is realized.

When detecting a fault such as a disconnection of a link on a single path over a VLAN, the STP automatically performs reestablishment processing of a new path. For this reason, a user can keep using a LAN to which the user is connected without being conscious of a change of path even if a fault has occurred.

However, such a series of processing by the STP is never completed instantaneously. Namely, it is generally said that it takes several tens of seconds to several minutes depending on a degree of change and a network scale before a topology converges and a network recovers a normal operation. During this time, the user connected to the concerned LAN can not use the network.

In the RSTP and the RSTP-based MSTP, the convergence time is extensively shortened to the order of milliseconds, thereby relieving a problem that the user can not use the network for a long time when a fault has occurred on the path.

However, both of the RSTP and the MSTP are respectively protocols for establishing a single loopless spanning tree (path) on each VLAN.

Accordingly, a frame (transmitted from a member of the concerned VLAN) mapped to the concerned VLAN is never transmitted/received through other links outside the spanning tree associated with each VLAN.

Also, it is practicably impossible to dynamically or intermittently change the path in the same VLAN.

Namely, when traffic within a VLAN suddenly surges and its response is lowered for example, and even if a link with a low working rate exists besides paths established by the STP or the like, the link can not be used unless a priority or the like of the L2 switch is reset and a new path is reestablished by the STP or the like. Thus, an optimum path change and a load distribution can not be realized.

On the other hand, as a technology enabling a dynamic path change, a layer 3 label switching by the MPLS (Multiple Protocol Label Switching) is remarkable.

This MPLS requires a plurality of complicated routing protocols such as OSPF (Open Shortest Path First), BGP4 (Border Gateway Protocol version 4), and LDP (Label Distribution Protocol).

An EoMPLS (Ethernet over MPLS) applying thereto the MPLS has been recently devised. The EoMPLS is a technology of transferring Ethernet data over the MPLS network and constructs a virtual Ethernet on the MPLS, thereby enabling a high-speed and large scale LAN to be constructed.

However, the EoMPLS is required to mount thereon a plurality of complicated routing protocols on the basis of MPLS, whereby developments of products realizing the EoMPLS and the system operation are made complicated.

This is against an advantage, which the Ethernet originally has, that an operation is easy. Therefore, it becomes impossible for the user to fully enjoy benefits the Ethernet originally provides.

### SUMMARY OF THE INVENTION

It is accordingly an object of the present invention to provide a LAN switch capable of recognizing a VLAN, whereby without mounting thereon a complicated protocol, an optimum path change and a load distribution can be performed, and a redundant path can be made.

In order to achieve the above-mentioned object, a LAN switching method according to the present invention comprises: a first step of establishing a plurality of VLAN's different from each other for a single group composed of a plurality of members, and a second step of mapping frames from the members to a predetermined VLAN selected from among the VLAN's (claim 1).

A plurality of VLAN's different from each other are associated with a single group composed of e.g. a plurality of members such as user terminals 300_1, . . . , 300_n (see FIG. 1).

Then, a frame from a member, e.g. the user terminal 300_1 is mapped to a predetermined VLAN selected from among a plurality of VLAN's.

By selecting a VLAN as required, it becomes possible to distribute frames to different VLAN's to be transmitted, or to transmit the frames with a predetermined VLAN being made redundant.

Also, the present invention may further comprise, between the first and the second steps, a third step of mapping a received frame to the group to which a source member of the frame belongs, based on information of the frame received, and the second step may map the frame to a predetermined VLAN selected from among a plurality of VLAN's of the group to which the frame has been mapped (claim 2).

Namely, at the third step, a received frame is mapped to a group to which a source member of the frame belongs based on information of the frame. At the second step, the frame is mapped to a predetermined VLAN selected from among a plurality of VLAN's of the group to which the frame has been mapped.

Thus, it becomes possible to map a frame transmitted from a member belonging to a different group to a group to which the concerned member belongs.

Also, according to the present invention, each path of the VLAN's may comprise a physical or a logical loopless path (claim 3).

Also, in order to achieve the above-mentioned object, a LAN switching method comprises: a first step of associating a plurality of paths with a VLAN having a plurality of members as components, and a second step of mapping frames from the members to a predetermined path selected from among the paths (claim 4).

Namely, a plurality of paths are associated with a VLAN having a plurality of members such as user terminals 300_1, . . . , 300_n as components. This corresponds to a VLAN being formed associated with each path on the VLAN, i.e. on a single group having a plurality of members as components.

A frame from e.g. the user terminal 300_1 is mapped to a predetermined path selected from among the paths.

By selecting a path as required, it becomes possible to distribute frames to paths to be transmitted, or to transmit the frames with a predetermined path being made redundant.

Also, according to the present invention, each path may comprise a physical or a logical loopless path (claim 5).

Namely, it is possible to make a path a physical path, a logical path established on e.g. a physical path, or a logical path on which a plurality of physical paths are aggregated. Also, since the path is loopless, no frame is copied.

In order to achieve the above-mentioned object, a LAN switch according to the present invention comprises: a VLAN table for associating a plurality of different VLAN's with a single group composed of a plurality of members, and a VLAN mapping portion for mapping frames from the members to a predetermined VLAN selected from the VLAN table (claim 6).

A principle (1) of the prevent invention will now be described referring to FIGS. 1 and 2. FIG. 1 shows a network 500 having LAN switches (edge switches) 100_1 and 100_2 (hereinafter, occasionally represented by a reference numeral 100) according to the present invention as components.

This network 500 is composed of the LAN switches 100_1 and 100_2 to which the user terminals 300_1 and 300_2 are respectively connected with links 400_1 and 400_2, and LAN switches (core switches) 200_1 and 200_2 (hereinafter, occasionally represented by a reference numeral 200).

Also, the edge switch 100 is provided with a VLAN mapping portion 15 and a VLAN table 60. It is to be noted that a VLAN group mapping portion 14 and a VLAN group table 50 shown in FIG. 1 will be described later.

FIG. 2 shows physical paths 43_1-43_4 connecting the edge switches 100_1 and 100_2.

The physical path 43_1 is a path passing through the edge switch 100_1, the link 400_2, the core switch 200_1, the link 400_5, and the edge switch 100_2. In FIG. 2, this physical path 43_1 is indicated by “-X-x-x′-X′-” arranging ports passed through from among the ports X, x, Y, y, z, z′, X′, x′, Y′, y′ shown in FIG. 1.

Similarly, the physical paths 43_2-43_4 are respectively indicated by “-Y-y-y′-Y′-”, “-X-x-z-z′-y′-Y′-”, and “-Y-y-z′-z-x′-X′-”.

A network connecting the user terminals 300_1 and 300_2 through the physical path 43_1 is regarded as a single VLAN. Similarly, networks connecting the user terminals 300_1 and 300_2 respectively through the physical paths 43_2-43_4 are regarded as other VLAN's.

Accordingly, four VLAN's exist for a single group having a plurality of members (user terminals 300_1 and 300_2) in the network 500. Hereinafter, these four VLAN's are referred to as a single “VLAN group”.

FIG. 3 shows a VLAN table 60 which e.g. the LAN switch 100_1 of the present invention is provided with. The VLAN table 60 associates a plurality of (three in FIG. 3) VLAN's whose ID's 63=“0×0000” “0×0001”, and “0×0002” with a single group.

It is to be noted that a VLAN group ID 61 and an output port 64 will be described later.

The VLAN mapping portion 15 of the LAN switch 100_1 maps (associates) a frame from the user terminal 300_1 to e.g. a VLAN whose ID 63=“0×0000” within VLAN's whose ID's 63=“0×0000”, “0×0001”, and “0×0002”, based on the VLAN table 60. This mapping method is selected as required.

Furthermore, the VLAN mapping portion 15 maps a subsequent frame from the user terminal 300_1 to e.g. the VLAN whose ID 63=“0×0001” based on the VLAN table 60.

According to such a LAN switch 100, it becomes possible to transmit the frames from the user terminals by a distributed transmission or a redundant transmission associated with a selection method of the VLAN.

It is to be noted that since the LAN switch 100 of the present invention has no function of dividing members having transmitted frames received into groups, all of the members having transmitted are regarded as members of a single group.

Accordingly, the LAN switch 100 of the present invention is associated with the edge switch 100 connecting members which belong to e.g. only a single group.

Also, in the LAN switch 100 of the present invention, only the edge switch 100 which receives frames from the user terminal 300 has only to mount the VLAN table 60 and the VLAN mapping portion 15. The core switch 200 and the edge switch 100 which transmits frames to the user terminal 300 do not have to mount thereon the VLAN table 60 and the VLAN mapping portion 15.

The core switch 200 has only to mount thereon e.g. a general VLAN tag lookup portion 31 and a tag switch 32 as shown in FIG. 1.

Furthermore, as for a protocol mounted on the edge switch 100 and the core switch 200, a protocol mounted on a general LAN switch is adequate, and is not necessary to be a complicated protocol. Thus, it is easy to develop and operate the LAN switch according to the present invention.

In order to achieve the above-mentioned object, a LAN switch according to the present invention comprises: a VLAN table for associating a plurality of paths with a single VLAN having same members as components, and a VLAN mapping portion for mapping frames from the members to a predetermined path selected from among the paths (claim 7).

Namely, the VLAN table associates a plurality of paths with a VLAN having a plurality of same members (e.g. the user terminals 300_1 and 300_2) as components.

A table having only the item of the above-mentioned output port 64 in the VLAN table 60 of FIG. 3 is a VLAN table of the present invention in a port method-VLAN (VLAN based on port).

In this table, a plurality of paths (paths associated with each output port 64) are associated with a single VLAN (e.g. VLAN group ID 61=“0×0000” in FIG. 3).

This association can be regarded as a VLAN (VLAN ID 63 in FIG. 3) associated with each path composed on the VLAN (VLAN group ID 61=“0×0000” in FIG. 3), i.e. in a single group having a plurality of same members as components.

The VLAN mapping portion 15 maps frames from the member (e.g. the user terminal 300_1) to a predetermined path selected from among the paths.

According to such a LAN switch 100, it becomes possible to perform a path change associated with a path selection method, a distributed transmission, or a redundant transmission of the frames from the user terminals.

Also, according to the present invention, each path of the VLAN's may comprise a physical or a logical path (claim 8).

Also, according to the present invention, each path may comprise a physical or a logical path (claim 9).

Also, according to the present invention, the path may be loopless (claim 10).

Also, according to the present invention, the path may be selected by a spanning tree protocol (claim 11).

Namely, it is possible to make e.g. a physical path loopless or loop-free. The edge switch 100 can easily make a physical path a loopless spanning tree by mounting an industry-standard protocol such as GARP (Generic Attribute Registration Protocol) and GMRP (GARP Multicast Registration Protocol). Thus, frames are prevented from being copied.

It is to be noted that when the network is loopless, it is not necessary to mount thereon a spanning tree protocol.

Also, the present invention may further comprise a VLAN group table for associating information of a frame with the group to which a source member of the frame belongs, and a VLAN group mapping portion for mapping a received frame to an associated group based on information of the frame by looking up the VLAN group table, and the VLAN mapping portion may map the frame to a predetermined VLAN of the group selected from the VLAN table (claim 12).

FIG. 4 shows an example of the VLAN group table 50, which is for mapping frames to a group (hereinafter, occasionally referred to as VLAN group) especially in a port method.

The table 50 associates an input port 51 (mapping condition) having received frames with a VLAN group ID 52 which is a group ID.

The VLAN group mapping portion 15 maps the concerned frame to the VLAN group whose ID 52 =“0×0000” associated with the input port No.=“0” having received the frame by looking up e.g. the table 50.

As for a rule which associates frames with a VLAN group 100, e.g. a MAC address method, a protocol method, an IP subnet method, or the like besides the above-mentioned port method can be applied.

Thus, the LAN switch 100 can map a frame transmitted from e.g. a member belonging to a different group (e.g. user terminals 300_1 and 300_2 belong to a group whose ID =“0×0000” and user terminals 300_3-300_5 (not shown) belong to a group whose ID=“0×0001”) to a group to which the member belongs.

In the above-mentioned present invention, the VLAN table 60 in FIG. 3 has only to indicate association between a group and a plurality of VLAN's for a single group (e.g. VLAN group ID=“0×0000”).

On the other hand, it is required in the present invention to indicate association between a group and a plurality of VLAN's for each group (e.g. VLAN group ID=“0×0000”, “0×0001”, . . . ).

Also, the present invention may further comprise a line fault detector for detecting a line fault on each VLAN, and the VLAN mapping portion may map the frame to a predetermined VLAN based on fault information from the line fault detector (claim 13).

FIG. 5 shows a principle (2) of the present invention. The arrangement of the network 500 in FIG. 5 is the same as that of the network 500 in FIG. 1. The LAN switch (edge switch 100 in FIG. 5) of the present invention is different from that of the principle (1) shown in FIG. 1 in that a line fault detector 19 is further provided.

When a line (link) fault has occurred in e.g. the link 400_5, the line fault detector 19 detects line faults in the VLAN's whose ID's=“0×0000” and “0×0003” respectively associated with the physical paths 43_1 and 43_4 (see FIG. 2).

Based on this line fault information, the VLAN mapping portion 15 has only to map the frames having been mapped to the VLAN whose ID=“0×0000” to the VLAN (=physical path 43_2) whose ID is “0×0001” or the VLAN (=physical path 43_3) whose ID=“0×0002”, which do not pass through the link 400_5, to be transmitted.

Also, according to the present invention, the VLAN mapping portion may sequentially map the frame to each VLAN per frame (claim 14).

Namely, the VLAN mapping portion 15 maps e.g. a frame 800_1 (not shown) received first to the VLAN (physical path 43_1; see FIG. 2) whose ID=“0×0000”, and then sequentially maps frames 800_2-800_5 (not shown) to the VLAN's (physical paths 43_2, 43_3, 43_4, and 43_1) whose ID's=“0×0001”, “0×0002”, “0×0003”, and “0×0000”.

Thus, it becomes possible to sequentially distribute frames to the VLAN's (physical paths 43_1-43_4) whose ID's=“0×0000”, “0×0001”, “0×0002”, and “0×0003” to be transmitted.

Also, according to the present invention, the VLAN mapping portion may map the frame to a VLAN different from a VLAN to which a frame has been mapped by a VLAN mapping portion of another LAN switch (claim 15).

Namely, the VLAN mapping portions 15 of the LAN switches 100 respectively map the frames to be transmitted to the different VLAN's.

In FIG. 1, for example, the edge switch 100_1 transmits the frame from the user terminal 300_1 to the edge switch 100_2 through the VLAN (physical path 43_1; see FIG. 2) whose ID=“0×0000”.

On the other hand, the edge switch 100_2 transmits the frame from the user terminal 300_2 to the edge switch 100_1 through the VLAN (physical path 43_2) whose ID=“0×0001” different from the VLAN whose ID=“0×0000”.

Thus, it becomes possible to distribute the frames to be transmitted.

Also, the present invention may further comprise a frame classifier for classifying received frames to a plurality of classes, and the VLAN mapping portion may map the frames to VLAN's associated with the classes (claim 16).

FIG. 6 shows a principle (3) of the present invention. The arrangement of the network 500 shown in FIG. 6 is the same as that of the network 500 shown in FIG. 1. However, the edge switch 100 in FIG. 6 is different from that of the principle (1) shown in FIG. 1 in that it is further provided with a frame classifier 20.

The frame classifier 20 classifies (according to e.g. destination) received frames based on a predetermined standard. The VLAN mapping portion 15 maps the frame to the VLAN associated with the class.

Thus, it becomes possible to distribute the frames according to their classes to be transmitted.

Also, the present invention may further comprise a path monitor for monitoring a response on each VLAN, and the VLAN mapping portion may map a frame, when the path monitor detects a VLAN having a lowered response, having been mapped to the VLAN to another VLAN (claim 17).

Namely, a path monitor monitors a response on each VLAN, and notifies a detected VLAN having a lowered response to the VLAN mapping portion.

The VLAN mapping portion maps the frames having been mapped to the notified VLAN to another VLAN.

Thus, it becomes possible for the LAN switch to realize a selection of an optimum path.

Also, the present invention may further comprise a path selector for transmitting, when a frame having an IP packet capsuled is received, a ping frame to a member having a destination IP address of the IP packet, and for selecting an optimum VLAN, based on a response time of the transmission, from among a plurality of VLAN's associated with the concerned frame, and the VLAN mapping portion may map the frame having the IP packet capsuled for the IP address to the optimum VLAN (claim 18).

Namely, when receiving a frame having an IP packet capsuled, a path selector transmits a ping frame to a member having a destination IP address of the IP packet, and treats a VLAN (path) whose response time is the shortest, for example, as an optimum VLAN within a plurality of VLAN's associated with the concerned frame.

The VLAN mapping portion maps the frame having the IP packet capsuled for the IP address to the optimum VLAN.

Also, the present invention may further comprise a pause frame storage for monitoring a number of pause frames received on each VLAN, and for notifying the VLAN mapping portion of a VLAN in which the number of pause frames within a predetermined time exceeds a specified value, and the VLAN mapping portion may map a frame having been mapped to the VLAN to another VLAN (claim 19).

Namely, a pause frame storage monitors a pause frame number received in each VLAN, and notifies that the pause frame number exceeds a specified value within a predetermined time, to the VLAN mapping portion.

The VLAN mapping portion maps the frame having been mapped to the VLAN to another VLAN.

Thus, it becomes possible for the VLAN mapping portion to select an optimum VLAN.

Also, the present invention may further comprise an error frame storage for storing a number of frames including errors within a predetermined time on each VLAN, and for determining whether or not the number has reached a predetermined specified value, and the VLAN mapping portion may map, based on the determination result, a frame having been mapped to the VLAN having reached the specified value to another VLAN (claim 20).

Namely, an error frame storage stores a number of frames including errors in the received frames for each VLAN. The error frame storage determines whether or not the number of frames including the errors has reached a predetermined specified value.

The VLAN mapping portion avoids selecting the VLAN from which many frames with errors are transmitted, for example, based on the determination result.

Also, the present invention may further comprise an alarm processor for broadcasting an alarm transferring frame notifying a VLAN on which a fault has occurred through a designated VLAN, based on an alarm distribution request from the line fault detector, and the line fault detector may provide the alarm processor with an alarm distribution request requesting to transmit the alarm transferring frame through a VLAN on which a fault has occurred when a line fault on the VLAN has been detected, and may provide the alarm processor with an alarm distribution request requesting to transmit the alarm transferring frame through VLAN's except the VLAN on which a fault has occurred when an alarm transferring frame has been received from another LAN switch (claim 21).

Namely, when having detected a line fault on the VLAN, the line fault detector provides an alarm distribution request for requesting to transmit an alarm transferring frame through the VLAN on which a fault has occurred to the alarm processor.

Also, when having received the alarm transferring frame from another LAN switch, the line fault detector provides an alarm distribution request for requesting to transmit an alarm transferring frame through VLAN's except the VLAN on which a fault has occurred to the alarm processor.

The alarm processor receives the alarm distribution request, and broadcasts the alarm transferring frame for notifying a VLAN in which a fault has occurred through a designated VLAN.

Thus, it becomes possible to notify a line fault to all of the LAN switches on the VLAN where a fault has occurred, and to map frames transmitted on the concerned LAN to another VLAN which belongs to the same group.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle (1) of a LAN switch according to the present invention;

FIG. 2 is a diagram showing an association example of a VLAN group, a VLAN, and a physical path in a LAN switch according to the present invention;

FIG. 3 is a diagram showing a VLAN table example in a LAN switch according to the present invention;

FIG. 4 is a diagram showing a VLAN group table example in a LAN switch according to the present invention;

FIG. 5 is a block diagram showing a principle (2) of a LAN switch according to the present invention;

FIG. 6 is a block diagram showing a principle (3) of a LAN switch according to the present invention;

FIG. 7 is a block diagram showing embodiments (1) and (5) of a LAN switch according to the present invention;

FIG. 8 is a diagram showing a VLAN group table example in embodiments (1)-(10) of a LAN switch according to the present invention;

FIG. 9 is a diagram showing a VLAN table example in embodiments (1) and (5) of a LAN switch according to the present invention;

FIG. 10 is a flow chart showing an operation procedure example in an embodiment (1) of a LAN switch according to the present invention;

FIG. 11 is a block diagram showing an embodiment (2) of a LAN switch according to the present invention;

FIG. 12 is a diagram showing a VLAN table example in embodiments (2) and (10) of a LAN switch according to the present invention;

FIG. 13 is a flow chart showing an operation procedure example in an embodiment (2) of a LAN switch according to the present invention;

FIG. 14 is a block diagram showing an embodiment (3) of a LAN switch according to the present invention;

FIG. 15 is a diagram showing a VLAN table example in an embodiment (3) of a LAN switch according to the present invention;

FIG. 16 is a block diagram showing an embodiment (4) of a LAN switch according to the present invention;

FIG. 17 is a diagram showing a VLAN table example in an embodiment (4) of a LAN switch according to the present invention;

FIG. 18 is a flow chart showing an operation procedure example in an embodiment (4) of a LAN switch according to the present invention;

FIG. 19 is a block diagram showing an embodiment (6) of a LAN switch according to the present invention;

FIG. 20 is a diagram showing a VLAN table example in embodiments (6), (8), and (9) of a LAN switch according to the present invention;

FIG. 21 is a block diagram showing an embodiment (7) of a LAN switch according to the present invention;

FIG. 22 is a diagram showing a VLAN table example in an embodiment (7) of a LAN switch according to the present invention;

FIG. 23 is a block diagram showing an embodiment (8) of a LAN switch according to the present invention;

FIG. 24 is a block diagram showing an embodiment (9) of a LAN switch according to the present invention;

FIG. 25 is a block diagram showing an embodiment (10) of a LAN switch according to the present invention;

FIG. 26 is a block diagram showing an arrangement of a general LAN network; and

FIG. 27 is a block diagram showing a LAN network to which a general spanning tree is introduced.

### DESCRIPTION OF THE EMBODIMENTS

Embodiments (1)-(10) of a LAN switch according to the present invention will now be described. These embodiments (1)-(10) are also those for a LAN switch applying thereto a LAN switching method according to the present invention.

Embodiment (1): VLAN Mapping as Required

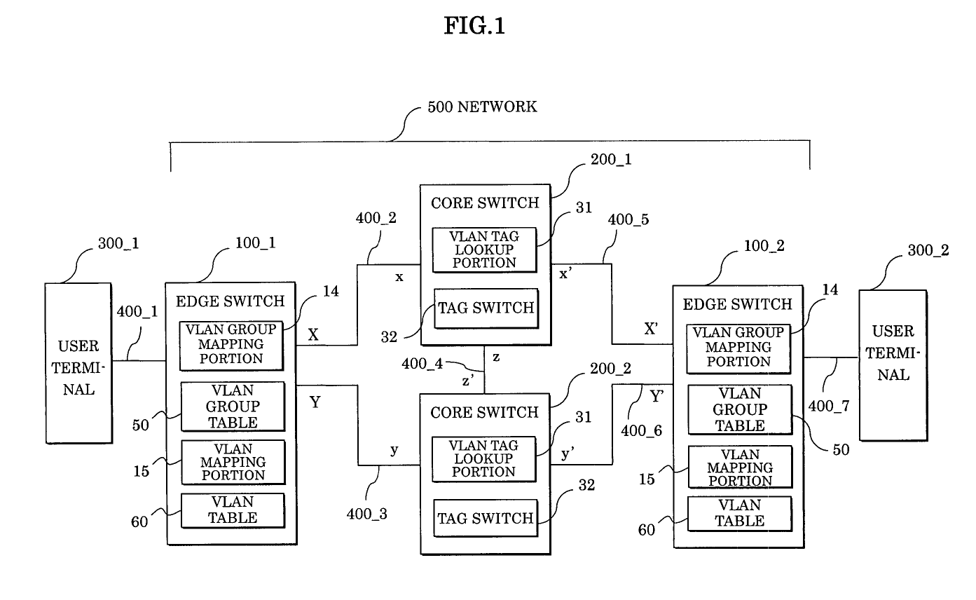

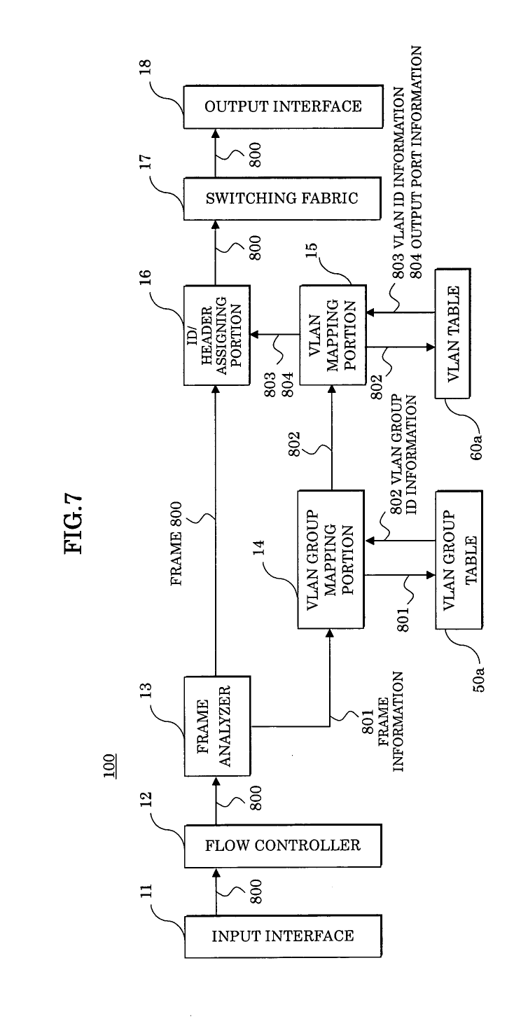

FIG. 7 shows an embodiment (1) of a LAN switch 100 according to the present invention. This LAN switch 100 is equivalent to e.g. the edge switch 100_1 which receives the frame 800 from the user terminal 300_1 in the network 500 in FIG. 1.

The LAN switch 100 is provided with an input interface 11, a flow controller 12, a frame analyzer 13, an ID/header assigning portion 16, a switching fabric 17, and an output interface 18 which sequentially process the received frame 800 and are connected in cascade.

The LAN switch 100 is further provided with a VLAN group mapping portion 14, a VLAN group table 50a, a VLAN mapping portion 15, and a VLAN table 60a.

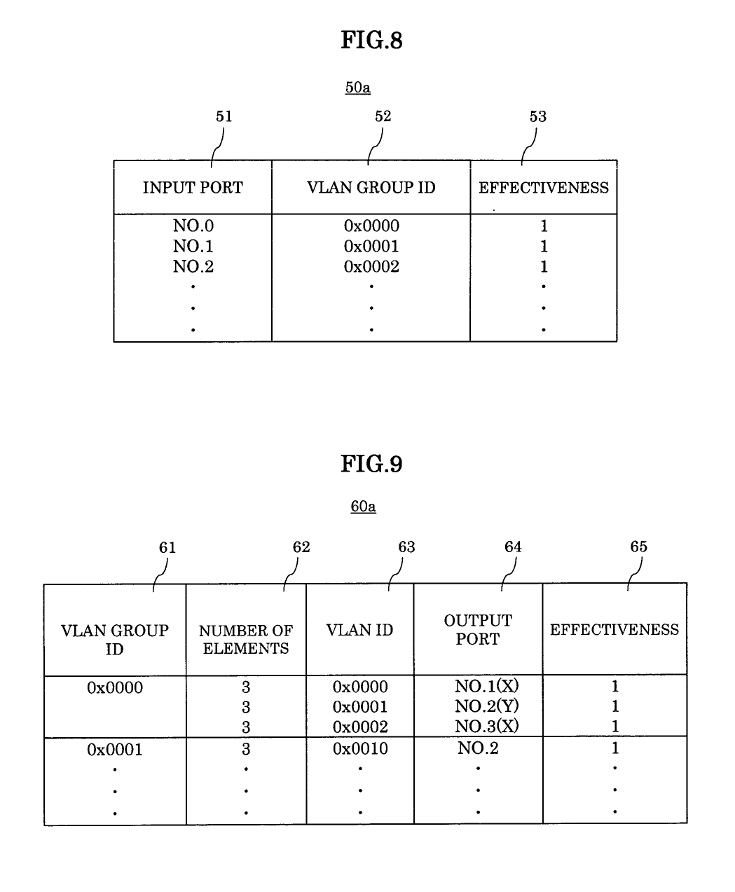

FIG. 8 shows an example of a VLAN group table 50a for performing a mapping of a VLAN group by a port method in this table 50a, an input port 51, a VLAN group ID 52, and an effectiveness 53, which are all mapping conditions, are associated with each other.

FIG. 9 shows an example of a VLAN table 60a. In this table 60a, a VLAN group ID 61, a number of elements 62, a VLAN ID 63, an output port 64, and an effectiveness 65 are associated with each other.

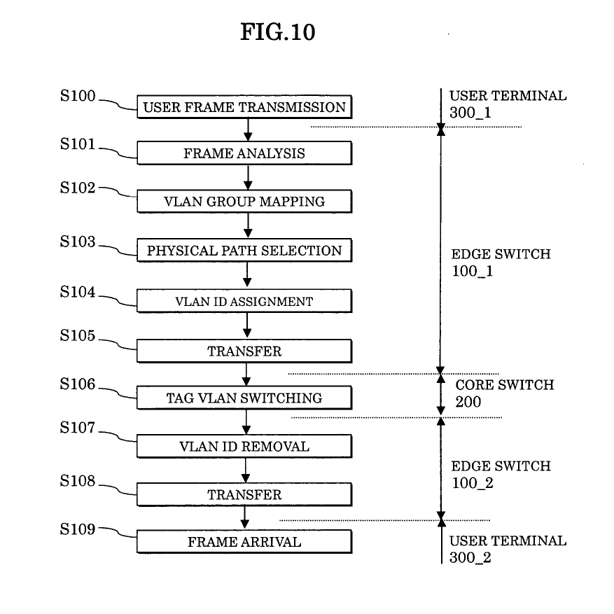

FIG. 10 shows an operation procedure of the LAN switch 100 placed as the edge switch 100_1 in the network 500 in FIG. 1, and an operation procedure of the upstream user terminal 300_1, the downstream core switch 200, the edge switch 100_2, and the user terminal 300_2 of the LAN switch 100.

The operation procedure shown in FIG. 10 will now be described referring to FIGS. 7-9.

Firstly, the network 500 is an IEEE 802.3 network to which a port VLAN is introduced. Namely, it is supposed that the edge switch 100_1 maps frames flowing therein to a VLAN and assigns an ID of this VLAN, and the core switch 200 operates by using a tag VLAN based on the VLAN ID.

At this time, protocols inherently required for the VLAN such as GARP (Generic Attribute Registration Protocol) and GVRP (GARP VLAN Registration Protocol) possessed by a general L2 switch operate on the network 500, and other routing protocols do not have to operate.

It is to be noted that the network 500, to which the LAN switch according to the present invention of the embodiments (2)-(10) described later is applied, is supposed to be the above-mentioned network to which the VLAN is introduced.

Also, a MAC address method-VLAN, a protocol method VLAN, an IP subnet method-VLAN, or the like may be applied to the VLAN to be introduced besides the port method-VLAN. When these VLAN methods are introduced, tables associated with each method have only to be used as the VLAN group table 50a in FIG. 8.

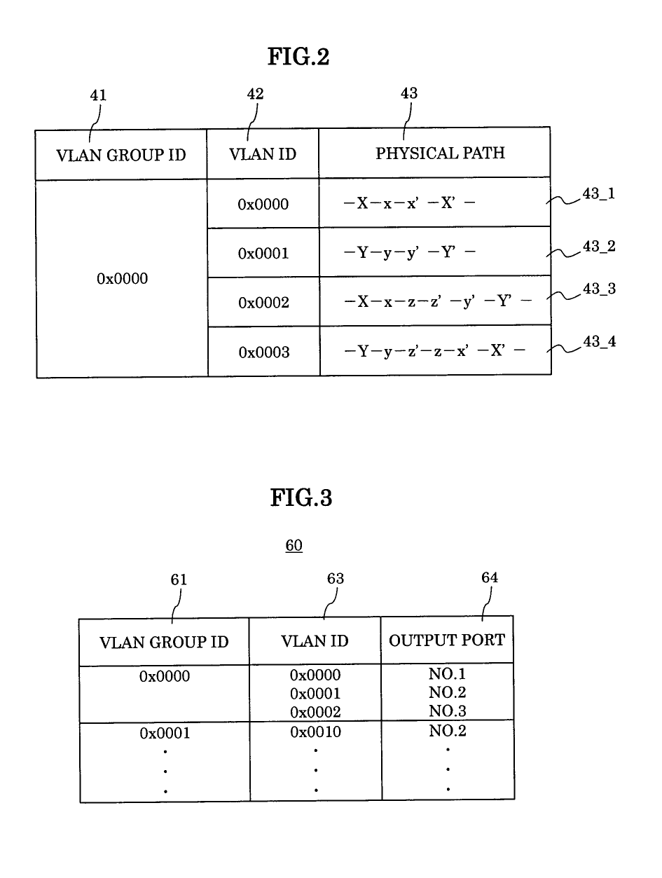

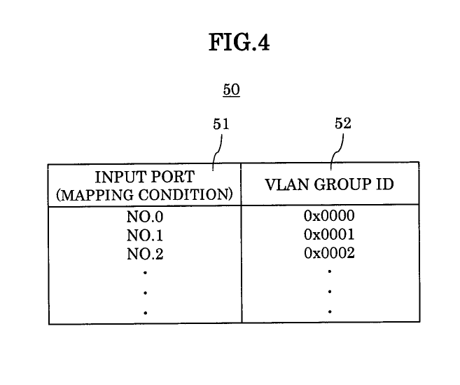

Also, in the network 500 in FIG. 1, three (number of elements) VLAN's (ID's=“0×0000” “0×0001” and “0×0002”) associated with different physical paths 43_1-43_3 (see FIG. 2; physical path 43_4 is not used as a VLAN in the embodiment (1)) having completely the same members (user terminals 300_1 and 300_2) are treated as a VLAN group (ID=“0×0000”) (see FIGS. 8 and 9).

Also, in the network 500 in FIG. 1, the user terminal 300 associated with the VLAN group whose ID's=“0×0001”, “0×0002” . . . is not shown.

Furthermore, the value associated with the network 500 is shown in parentheses in the output port 64 of the VLAN table 60a in FIG. 9.

Step S100: The user terminal 300_1 outputs the frame 800 addressed to the user terminal 300_2.

Step S101: After interface processing and flow control are respectively performed to the frame 800 at the input interface 11 and the flow controller 12 in the edge switch 100_1 (LAN switch 100), the frame 800 is provided to the frame analyzer 13.

The frame analyzer 13 transmits the frame 800 to the ID/header assigning portion 16, analyzes that the frame is inputted from a port whose port No. is e.g. “0” at the same time, and provides frame information 801=“input port No. 0” to the VLAN group mapping portion 14.

Step S102: The mapping portion 14 acquires, by looking up the table 50a (see FIG. 8), the VLAN group ID 52=“0×0000” associated with the input port 51=frame information 801=“0” as VLAN group ID information 802.

The mapping portion 14 provides this information 802=“0×0000” to the VLAN mapping portion 15.

Step S103: The VLAN mapping portion 15, by looking up the VLAN table 60a in FIG. 9, provides to the ID/header assigning portion 16 the only output port 64 (0×0001, “2(Y)”) changed/selected (mapped) as required, for example, from (among) the VLAN ID 63 and the output port 64=(0×0000, “1(X)”), (0×0001, “2(Y)”), and (0×0002, “3(X)”) associated with the VLAN group ID 61=information 802 =“0×0000” respectively as VLAN ID information 803=“0×0001” and output port information 804=“2” (“Y” in FIG. 1).

It is to be noted that as for the number of elements 62 in the VLAN table 60a, the number of elements 62 =“3” associated with the VLAN group ID 61=“0×0000”, for example, indicates that the number of the VLAN ID's associated with the VLAN group ID 61=“0×0000” is “3”. This number of elements 62 is added to the VLAN table 60a for convenience in referring.

Also, the effectiveness 65 indicates whether or not the VLAN ID 63 and the output port 64 are effective, and the VLAN ID 63 and the output port 64 whose effectiveness=“0” are not selected.

Step S104: The assigning portion 16 assigns an in-device header (e.g. output port No. “Y”) to the frame 800 and inserts (tags) the VLAN ID =“0×0001” into the frame 800 to be provided to the switching fabric 17.

Step S105: The switching fabric 17 switches over the frame 800 to the output port whose No. is 2(Y) to be provided to the output interface 18. The output interface 18 transfers the frame 800 from the output port 2 (Y).

Step S106: The core switch 200_1 (see FIG. 1) on the physical path 43_2 associated with the VLAN ID=“0×0001” executes general tag VLAN switching processing. Namely, the core switch 200 performs switching based on the VLAN ID=“0×0001” tagged to the frame 800.

As a result, the frame 800 is transferred to the edge switch 100_2.

Steps S107 and S108: The edge switch 100_2 executes general VLAN processing. Namely, after removing the VLAN ID from the frame 800, the edge switch 100_2 transfers the frame 800 to the user terminal 300_2.

Step S109: The user terminal 300_2 receives the frame 800.

Thus, the frame 800 is supposed to be transmitted from the terminal 300_1 to the terminal 300_2, both are the members of the same VLAN, through the VLAN with ID=“0×0001”.

Namely, in a plurality of VLAN's composing the same VLAN group, the members belonging thereto are completely the same even if they have physically different paths. Therefore, the frame belonging to the same VLAN group will reach the same user (member) group even if it is mapped to any VLAN.

Embodiment (2): VLAN Mapping Based on Line Fault

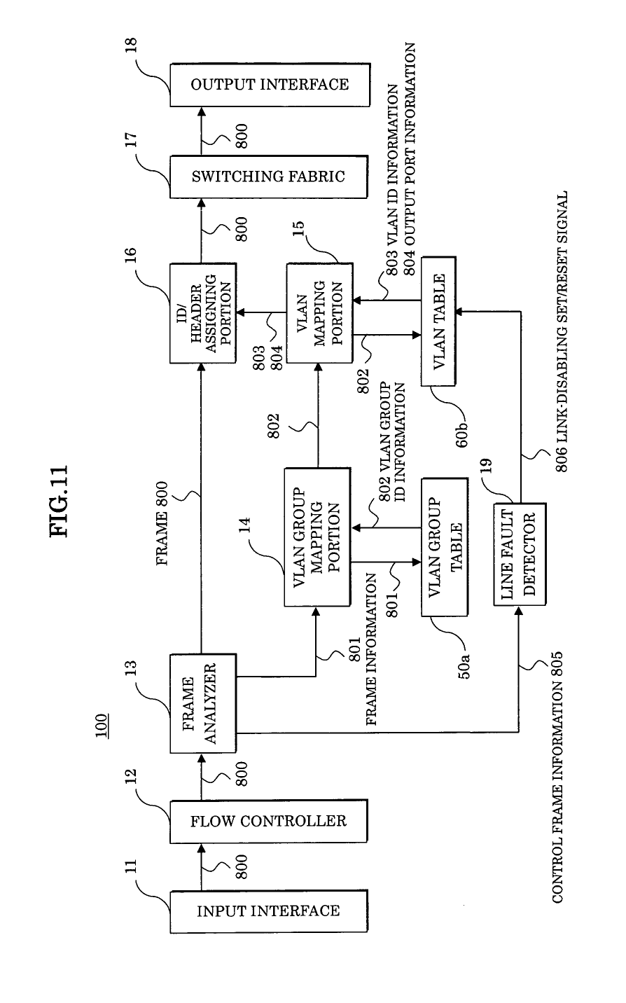

FIG. 11 shows an embodiment (2) of a LAN switch 100 according to the present invention. This LAN switch is different from the LAN switch 100 of the embodiment (1) shown in FIG. 7 in that a line fault detector 19 is further provided and a VLAN table 60b is substituted for the VLAN table 60a.

The basic operation of the LAN switch 100 in the embodiment (2) is the same as that of the LAN switch 100 in the embodiment (1). Therefore, the operation specifically different from the embodiment (1) will now be mainly described.

It is to be noted that the basic operation will be simply described also in the embodiments (3)-(10) described later.

In this embodiment (2), the line fault detector 19 detects a line fault and the VLAN table 60b displays the VLAN using the line in which a fault has occurred so that it may not be used.

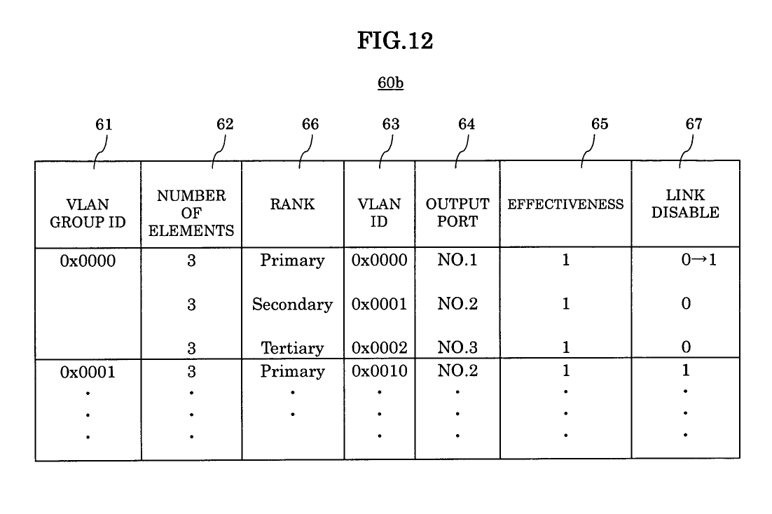

FIG. 12 shows an embodiment of the VLAN table 60b. This VLAN table 60b is different from the VLAN table 60a (see FIG. 9) in that items of a rank 66 indicating ranks (“primary”, “secondary”, or “tertiary”, etc.) of each VLAN (VLAN ID 63) and a link disable 67 (“0”: enabled: “1” disabled) indicating a line fault of each VLAN, i.e. whether or not a link is enabled are added.

It is to be noted that the VLAN group table 50a is the same as that of the embodiment (1) shown in FIG. 8.

When the frame 800 received from the flow controller 12 is a control frame, the frame analyzer 13 analyzes the control frame 800, and provides necessary control frame information 805 to the line fault detector 19.

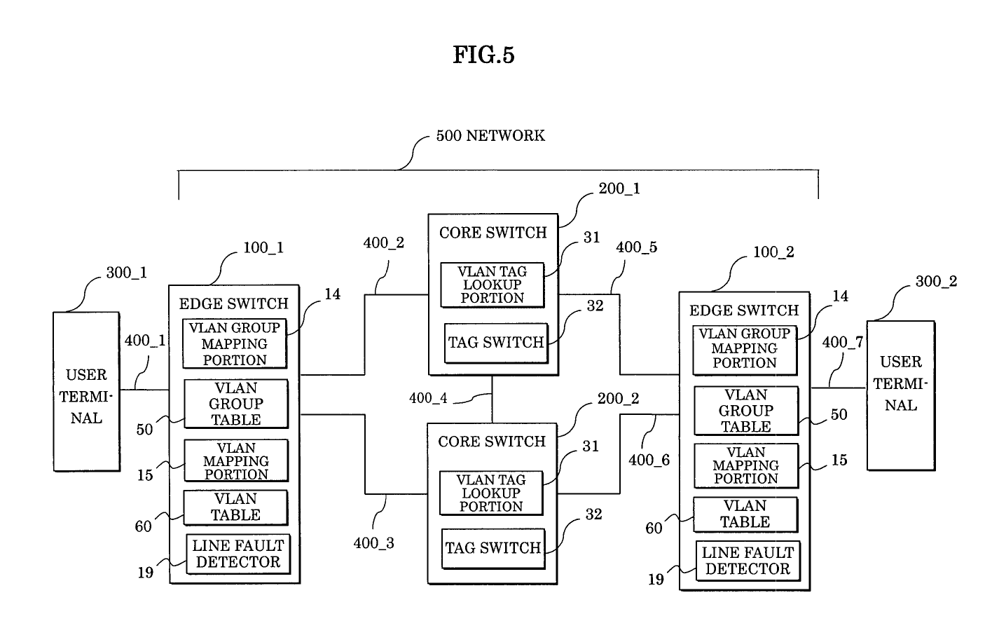

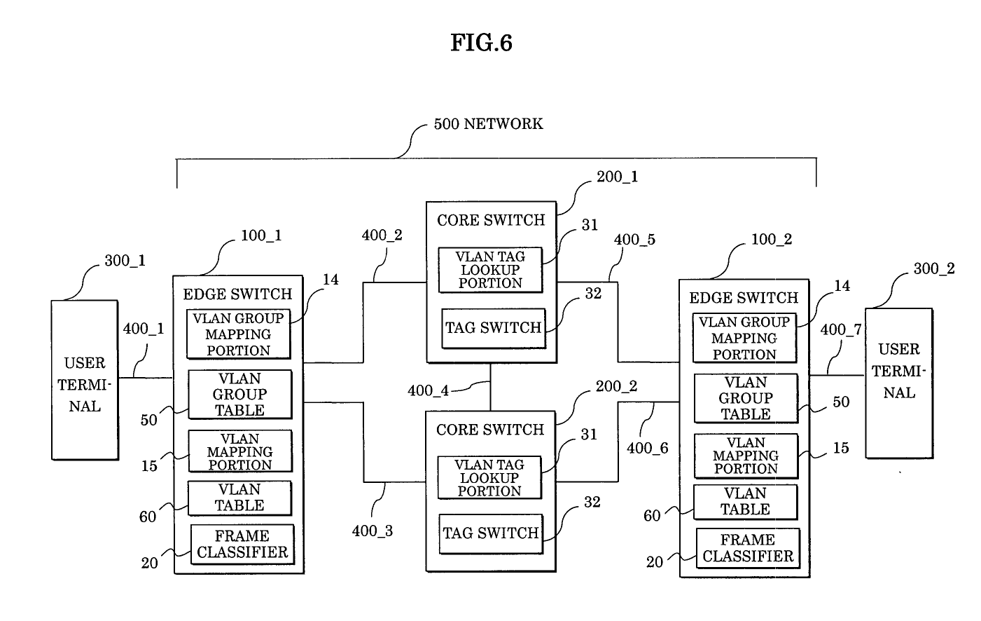

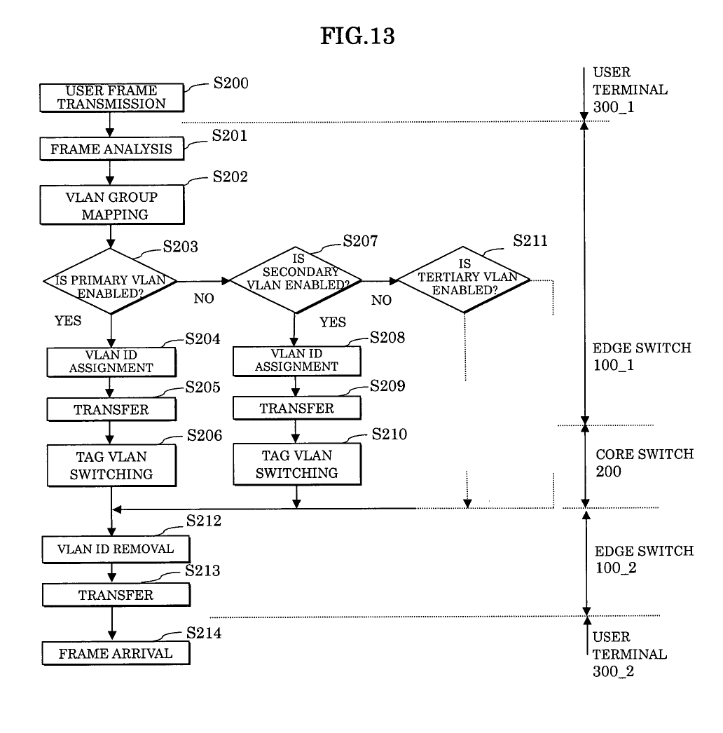

FIG. 13 shows an operation procedure of the embodiment (2). FIG. 13 shows an operation procedure in the case where the frame 800 is transmitted from the user terminal 300_1 to the user terminal 300_2 in the network 500 shown FIG. 5. The LAN switch 100 of the embodiment (2) is placed in the edge switch 100_1 in FIG. 5.

The operation procedure of the user terminals 300_1 and 300_2, the edge switch 100_1, the core switch 200, and the edge switch 100_2 shown in FIG. 13 will be described referring to FIGS. 11 and 12.

Step S200: The user terminal 300_1 transmits the frame 800 addressed to the user terminal 300_2.

Step S201: In the same way as step S101 of the embodiment (1) shown in FIG. 10, in the edge switch 100_1 (LAN switch 100 of the present invention), the frame analyzer 13 analyzes the frame 800 received through the input interface 11 and the flow controller 12, and then provides e.g. the frame information 801=“port No. 0” to the VLAN group mapping portion 14.

Step S202: In the same way as step S102 of the embodiment (1), the mapping portion 14 provides the VLAN group ID information 802=“0×0000” to the VLAN mapping portion 15.

Step S203: The VLAN mapping potion 15, by looking up the VLAN table 60b (see FIG. 12), obtains the VLAN ID 63=“0×0000” and the output port 64=“1” of the entry whose effectiveness 65=“1”, link disable 67=“0”, and rank 66 is the youngest “primary” from among entries associated with the VLAN group ID information 802=VLAN group ID 61=“0×0000”, respectively as the VLAN ID information 803 and the output port information 804.

Steps S204 and S205: In the same way as steps S104 and S105 of the embodiment (1), the frame 800 to which the VLAN ID=“0×0000” is tagged is outputted from an output port 1.

Steps S206 and S212-S214: In the same way as steps S106-S109 of the embodiment (1), the frame 800 is transferred to the user terminal 300_2 through the physical path associated with the VLAN ID=“0×0000”.

When a fault has occurred in the line used by the VLAN whose ID=“0×0000”, this fault is notified to the LAN switch 100 by the control frame.

The line fault detector 19 detects the link in which the fault has occurred based on the control frame information 805 from the frame analyzer 13, and sets the link disable 67 associated with the rank 66=“primary” and the VLAN ID 63=“0×0000” in the VLAN table 60b to “1” from “0” with a link-disabling set/reset signal 806.

Then, the edge switch 100_1 selects a VLAN to which the frame 800 is transmitted for the user terminal 300_2 by the user terminal 300_1 in the following way.

Step S203: Because of the link disable 67=“1” of the entry whose rank 66=“primary” associated with the VLAN group ID information 802=“0×0000”, by looking up the VLAN table 60b, the VLAN mapping portion 15 in the edge switch 100_1 selects an entry of the second youngest rank 66=“secondary” and the link disable 67=“0”.

The VLAN mapping portion 15 obtains the VLAN ID 63=“0×0001” and the output port 64=“2” of this entry respectively as the information 803 and 804.

Thus, the frame 800 is transferred to the user terminal 300_2 through the path associated with the VLAN whose VLAN ID=“0×0001”.

It is to be noted that when both link disables 67 of the entries whose ranks 66=“primary” and “secondary” of the VLAN group ID information 802=“0×0000” are “1”, namely, when faults have occurred in the lines used on the VLAN's whose VLAN ID's=“0×0000” and “0×0001”, the VLAN associated with the next rank 66=“tertiary” is selected.

When the line fault has recovered, the line fault detector 19 resets the value of the entry associated with the line fault recovery within the link disable 67 in the VLAN table 60b to “0” with the signal 806.

Thus, the redundant path of the LAN switch 100 is realized.

Embodiment (3): Sequential Switchover of VLAN Mapping

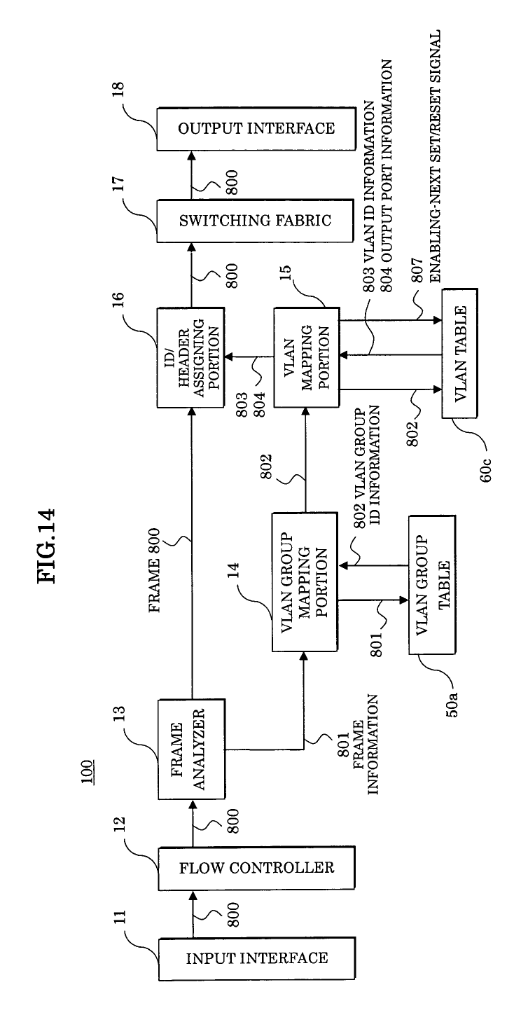

FIG. 14 shows an embodiment (3) of a LAN switch 100 according to the present invention. This LAN switch is different from the LAN switch 100 of the embodiment (1) shown in FIG. 7 in that a VLAN table 60c is substituted for the VLAN table 60a.

The LAN switch 100 of the embodiment (3) does not change/select a VLAN dynamically as required in the same way as the LAN switch in the embodiment (1), but sequentially selects a VLAN.

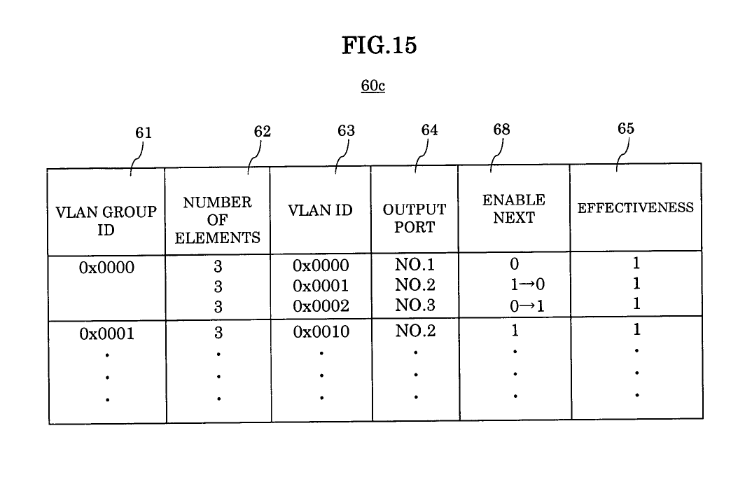

FIG. 15 shows an embodiment of the VLAN table 60c. This VLAN table 60c is different from the VLAN table 60a (see FIG. 9) in that an item of an enable next 68 (“1”: VLAN to be selected next, “0”: VLAN not to be selected) indicating the VLAN (VLAN ID 63) to be selected next is added. It is to be noted that the VLAN group table 50a is the same as that of the embodiment (1) shown in FIG. 8.

The operation procedure of the embodiment (3) is basically the same as that of the embodiment (1) shown in FIG. 10 except the operation of step S103.

Namely, at step S103, the VLAN mapping potion 15 obtains, respectively as the information 803 and 804, the VLAN ID 63=“0×0001” and the output port 64=“2” of the entry whose enable next 68=“1” and effectiveness 65=“1” from among entries whose information 802=VLAN group ID 61=“0×0000”, by looking up the VLAN table 60c (see FIG. 15).

Thus, the frame 800 is transferred by the path of the VLAN whose ID=“0×0001”.

Furthermore, the VLAN mapping portion 15 resets the enable next 68=“1” of the VLAN whose VLAN ID 63=“0×0001”, and sets the enable next 68 of the next VLAN whose VLAN ID 63=“0×0002” to “1”.

Thus, the frame 800 which belongs to the same VLAN group ID=“0×0000” and which has arrived at the edge switch 100_1 next is transferred to the path of the VLAN whose ID=“0×0002”.

It is to be noted that the VLAN ID selected next to the VLAN whose VLAN ID 63=“0×0002” is again “0×0000”. Also, when all of the enable next 68 associated with all of the VLAN's belonging to the entry of the same VLAN group=“0”, the primary VLAN of the entry is used.

Thus, it becomes possible to distribute traffic into a plurality of VLAN's to be transmitted. The operation of the embodiment (3) may be regarded that VLAN's (paths) are aggregated to transmit traffics in a different point of view.

Embodiment (4): VLAN Mapping Based on Frame Class

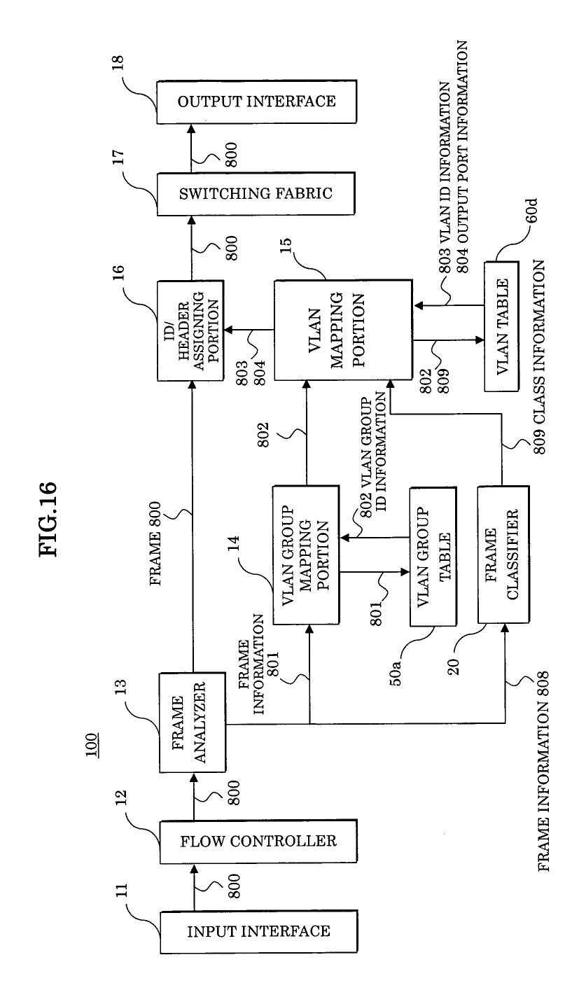

FIG. 16 shows an embodiment (4) of a LAN switch 100 according to the present invention. This LAN switch is different from that of the embodiment (1) shown in FIG. 7 in that a frame classifier 20 is further provided and a VLAN table 60d is substituted for the VLAN table 60a. It is to be noted that the VLAN group table 50a is the same as that of the embodiment (1) shown in FIG. 8.

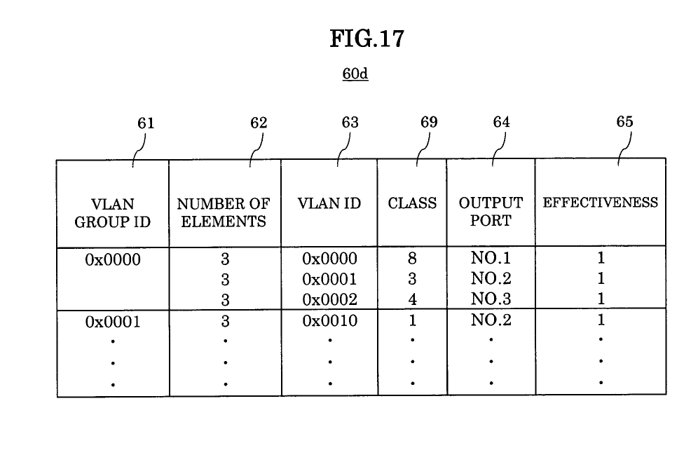

FIG. 17 shows an embodiment of the VLAN table 60d. This VLAN table 60d is different from the VLAN table 60a (see FIG. 9) in that an item of a class 69 indicating a class of the frame 800 as received is added.

In the embodiment (4), the VLAN transmitting frames 800 is selected based on the class of each frame.

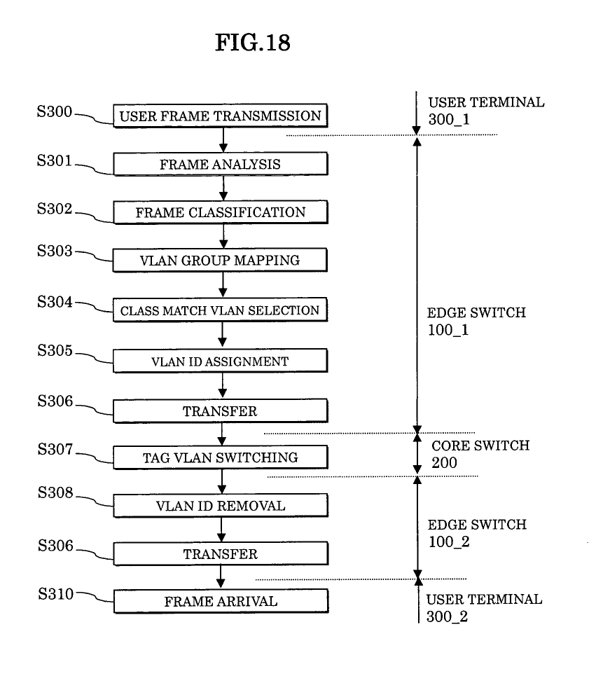

FIG. 18 shows an operation procedure of the embodiment (4). The operation of the embodiment (4) will now be described referring to FIGS. 16 and 17.

Step S300: In the same way as step S100 of the embodiment (1) shown in FIG. 10, the terminal 300_1 outputs the frame 800 addressed to the user terminal 300_2.

Step S301: In the same way as the step S101 of the embodiment (1), the frame analyzer 13 in the edge switch 100_1 transmits the frame 800 to the ID/header assigning portion 16, and provides the frame information 801 to the VLAN group mapping portion 14 at the same time.

Furthermore, the frame analyzer 13 analyzes the frame 800, and extracts frame information 808 necessary for a classification to be provided to the frame classifier 20.

Step S302: The frame classifier 20 classifies the frame 800 based on a preset classifying rule (e.g. class is determined based on the source of the frame 800) and the frame information 808, and provides a resultant, class information 809=e.g. “3” to the VLAN mapping portion 15.

Step S303: On the other hand, in the same way as step S102 of the embodiment (1), the mapping portion 14, by looking up the table 50a (see FIG. 8), provides the VLAN group ID information 802=“0×0000” associated with the frame information 801=“0” to the VLAN mapping portion 15.

Step S304: The VLAN mapping portion 15, by looking up the VLAN table 60d (see FIG. 17), obtains the VLAN ID 63=“0×0001” and the output port 64=“2” of the entry whose VLAN group ID 61=information 802=“0×0000”, class 69=information 809=“3”, and effectiveness 65=“1” respectively as the VLAN ID information 803 and the output port information 804.

Steps S305-S310: In the same way as steps S104-S109 of the embodiment (1), the in-device header and the VLAN ID are assigned to the frame 800 in the assigning portion 16, and after switching at the switching fabric 17, the frame 800 is outputted through the output interface 18.

Furthermore, the frame 800 is transferred through the core switch 200_2 and the edge switch 100_2 on the path of the VLAN whose ID=“0×0001”, and is received by the user terminal 300_2.

Thus, each frame 800 is transmitted from the terminal 300_1 to the terminal 300_2 through the VLAN associated with the class of its own frame.

Namely, it becomes possible to classify the frame 800 to be transmitted.

Embodiment (5): VLAN Mapping Associated With Edge Switch

The embodiment (5) of a LAN switch 100 according to the present invention will now be described referring to FIGS. 1 and 7-9 used in the description of the embodiment (1).

The arrangement of the LAN switch (edge switches 100_1 and 100_2; (see FIG. 1)) in the embodiment (5) is the same as that of the LAN switch in FIG. 7.

Also, the VLAN group table 50a and the VLAN table 60a used in the embodiment (5) are respectively the same as the VLAN group table 50a shown in FIG. 8 and the VLAN table 60a shown in FIG. 9.

In the same way as the embodiments (1)-(4), the user terminals 300_1 and 300_2 are supposed to belong to the VLAN group whose VLAN group ID=“0×0000”.

The edge switch 100_1 transfers the frame 800 received from the user terminal 300_1 only to the VLAN whose ID=“0×0000” associated with the VLAN group ID=“0×0000” in the VLAN table 60a, and the edge switch 100_2 transfers the frame 800 received from the user terminal 300_2 only to the VLAN whose ID=“0×0001” associated with the VLAN group ID=“0×0000” in the VLAN table 60a.

Thus, different VLAN's (paths) are selected for edge switches 100, and the load distribution is made possible.

Embodiment (6): VLAN Mapping Based on Path Monitoring Result

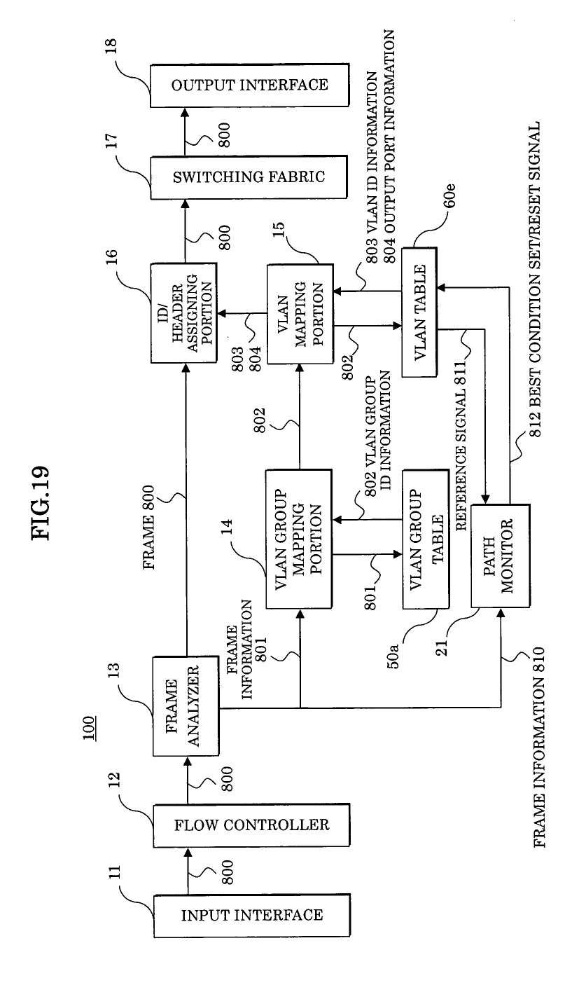

FIG. 19 shows an embodiment (6) of a LAN switch 100 according to the present invention. This LAN switch 100 is different from that of the embodiment (1) shown in FIG. 7 in that a path monitor 21 is further provided and a VLAN table 60e is substituted for the VLAN table 60a (see FIG. 9). It is to be noted that the VLAN group table 50a is the same as that shown in FIG. 8.

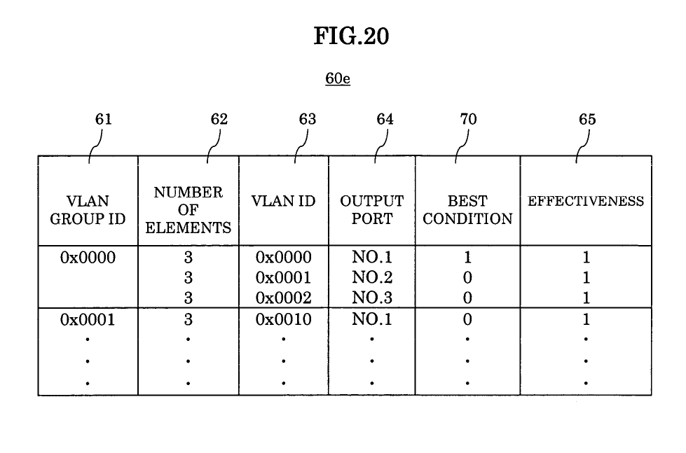

FIG. 20 shows the VLAN table 60e, which is different from the VLAN table 60a in that an item of a best condition 70 (“1”: optimum path, “0”: path which is not optimum) indicating a VLAN whose response is best within a plurality of VLAN's belonging to the same VLAN group is added.

The path monitor 21 always monitors traffics on each VLAN based on frame information 810 of the frame 800 flowing therein from the network side, and detects a lowered response per VLAN.

The path monitor 21, by looking up the VLAN table 60e with a reference signal 811, sets the item of the best condition 70 associated with the VLAN whose response is best within the same VLAN group to “1” with a best condition set/reset signal 812, and resets the item of the other VLAN's to “0”.

The VLAN mapping portion 15 acquires the VLAN ID 63=“0×0000” and the output port 64=“1” having the best condition 70=“1” and the effectiveness=“1” in the entries whose VLAN group ID=“0×0000” to which e.g. the frame 800 belongs, and provides these as the information 803 and 804 to the ID/header assigning portion 16.

Thus, the frame 800 is transferred to the user terminal 300_2 through the VLAN whose response is best.

Embodiment (7): VLAN Mapping Based on Optimum Path Selection Result

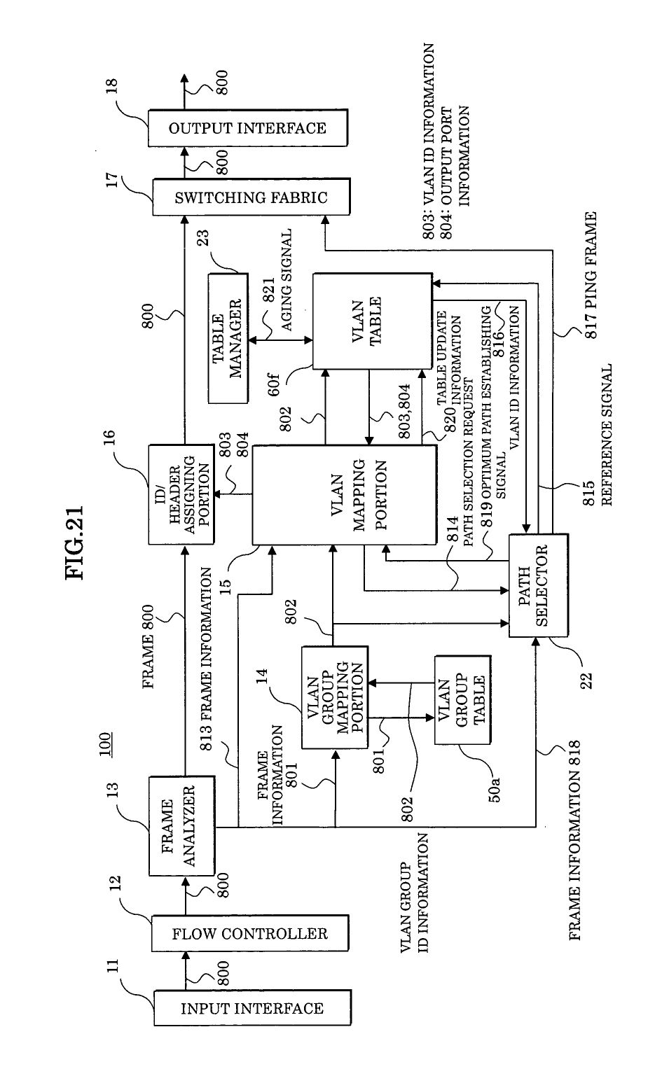

FIG. 21 shows an embodiment (7) of a LAN switch 100 according to the present invention. This LAN switch is different from that shown in FIG. 7 in that a path selector 22 and a table manager 23 are further provided, and a VLAN table 60f is substituted for the VLAN table 60a (see FIG. 9). It is to be noted that the VLAN group table 50a is the same as that shown in FIG. 8.

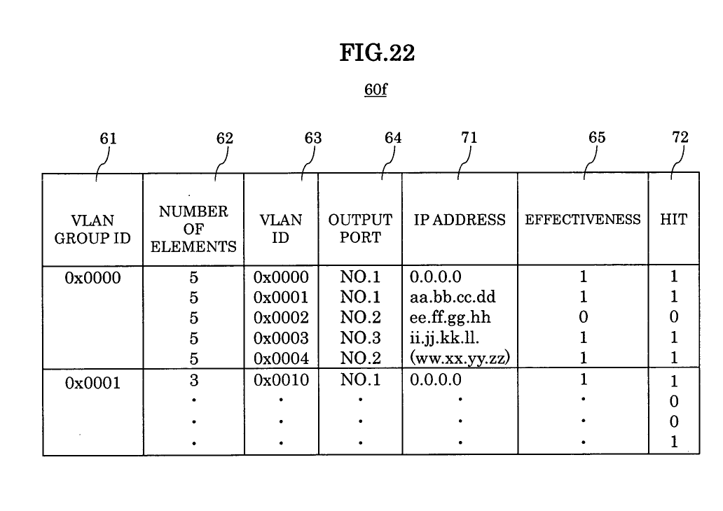

FIG. 22 shows the VLAN table 60f. This VLAN table 60f is different from the VLAN table 60a in that items of an IP address 71 and a hit 72 are added in the embodiment (7), the frame 800 is mapped to the VLAN based on a destination address of an IP packet capsuled in the frame 800.

The item of the IP address 71 is for mapping a frame to a VLAN according to a destination IP address of an IP packet when the IP packet is capsuled in the frame 800.

The item of the hit 72=“1” indicates that the frame 800 having the IP packet capsuled for the IP address shown in the item of the IP address 71 is transferred within a preset fixed time (aging time).

In operation, the frame analyzer 13 analyzes the contents of the received frame 800, and provides the frame information 801 necessary for mapping to the VLAN group to the VLAN group mapping portion 14.

Also, when the frame 800 has a capsuled protocol or a capsuled IP packet, the frame analyzer 13 provides the frame information 813 such as the destination IP address to the VLAN mapping portion 15.

Furthermore, the frame analyzer 13 transmits the frame 800 to the ID/header assigning portion 16.

The VLAN group mapping portion 14, by looking up the VLAN group table 50a, provides the VLAN group ID associated with the frame information 801 with the information 802 to the VLAN mapping portion 15 and the path selector 22.

When receiving the frame information 813 indicating that the packet of the protocol except the IP protocol is capsuled, the VLAN mapping portion 15, by looking up the VLAN table 60f, acquires the VLAN ID 63=“0×0000” and the output port 64=“1” of the entry whose IP address 71=“default: 0.0.0.0” within a plurality of VLAN's composing the concerned VLAN group.

Thus, the frame 800 is transferred to the VLAN whose ID=“0×0000” associated with the “protocol except IP protocol”.

On the other hand, when receiving e.g. the frame information 813=destination IP address “aa.bb.cc.dd”, the VLAN mapping portion 15, by looking up the VLAN table 60f, acquires the VLAN ID 63=“0×0001” and the output port 64=“1” of the entry whose information 802=VLAN group ID=“0×0000”, frame information 813=destination IP address=“aa.bb.cc.dd”, effectiveness=“1”.

When the item of the hit 72 of the concerned entry=“0”, the VLAN mapping portion 15 sets the hit 72=“1”.

Thus, the frame 800 is transferred to the VLAN whose ID=“0×0001” associated with the destination IP address=“aa.bb.cc.dd”.

Also, when receiving e.g. the frame information 813=destination IP address “ww.xx.yy.zz” not registered in the item of the IP address 71 in the VLAN table 60f, the VLAN mapping portion 15 transmits a path selection request 814 for requesting a selection of a path including the destination IP address “ww.xx.yy.zz” to the path selector 22.

The path selector 22 provides a reference signal 815=VLAN group ID information 802=“0×0000” to the VLAN table 60f, and acquires the ID's of all of the VLAN's composing the VLAN group whose ID=“0×0000” with VLAN ID information 816.

Furthermore, the path selector 22 transmits a ping frame 817 for the IP address=“ww.xx.yy.zz” through the VLAN acquired with the information 816.

The path selector 22 receives a response for the ping frame 817 as frame information 818, and provides, based on this response time, an optimum path establishing signal 819 indicating the VLAN whose condition is best (e.g. VLAN whose ID=“0×0004”) to the VLAN mapping portion 15.

Namely, when monitoring traffics on each VLAN, and the frame 800 is the IP packet capsuled, the path selector 22 selects an optimum path by the response time for the ping frame 817 from among a plurality of paths (VLAN's) to the user terminal 300 having the destination IP address.

The VLAN mapping portion 15, based on the signal 819, associates the VLAN ID=“0×0004” with the concerned IP address=“ww.xx.yy.zz” to be registered in the VLAN table 60f. Then, the VLAN mapping portion 15 sets the effectiveness of the entry=“1” and the hit 72=“1”.

The VLAN mapping portion 15 provides the VLAN ID information 803=“0×0004” and the output port information 804=“2” to the ID/header assigning portion 16.

Hereafter, by the same operation as the embodiment (1), the frame 800 having the IP packet (destination IP address=“ww.xx.yy.zz”) capsuled is transferred by using the optimum VLAN whose ID=“0×0004”.

The table manager 23 processes aging to the VLAN table 60f per preset time (aging time). Namely, when the hit 72=“1” at the time of aging, the table manager 23 sets the hit 72=“0”, and when the hit 72=“0”, the table manager 23 sets the effectiveness 65=“0”.

Thus, the association between an old IP address and a VLAN ID is deleted without being accessed.

Embodiment (8): VLAN Mapping Based on Pause Frame

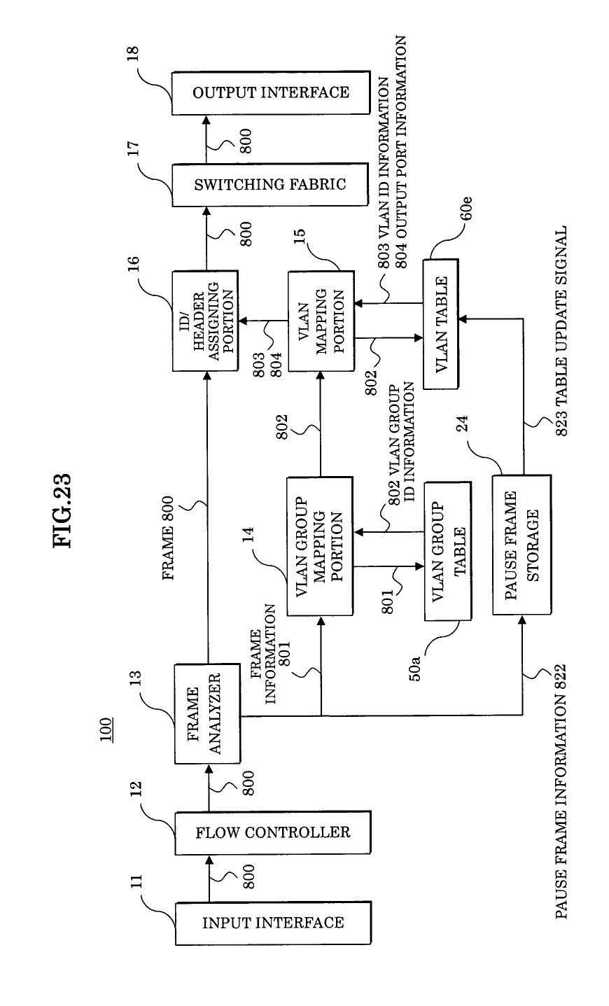

FIG. 23 shows an embodiment (8) of a LAN switch 100 according to the present invention. This LAN switch 100 is different from that shown in FIG. 7 in that a pause frame storage 24 is further provided and the VLAN table 60e is the same as that of the embodiment (6) shown in FIG. 20. It is to be noted that the VLAN group table 50a is the same as that shown in FIG. 8.

The storage 24 always monitors a port on the network side, i.e. traffics on each VLAN, and stores a number of pause frames received within a preset fixed time for each VLAN.

Furthermore, the storage 24 provides a table update signal 823 to the VLAN table 60e, writes “1” in the best condition 70 associated with the VLAN whose reception rate of the pause frames is the lowest within the same VLAN group, and writes “0” in the best condition 70 of other VLAN's.

By looking up the VLAN table 60e, the VLAN mapping portion 15 acquires the VLAN ID=“0×0000” and the output port No.=“1” having the best condition 70=“1” from among the entries whose VLAN group ID information 802=“0×0000”.

The operation of the LAN switch hereafter is the same as that of the embodiment (1).

Thus, the frame 800 is transferred by a VLAN whose condition is the best.

Embodiment (9): VLAN Mapping Based on Error Frame

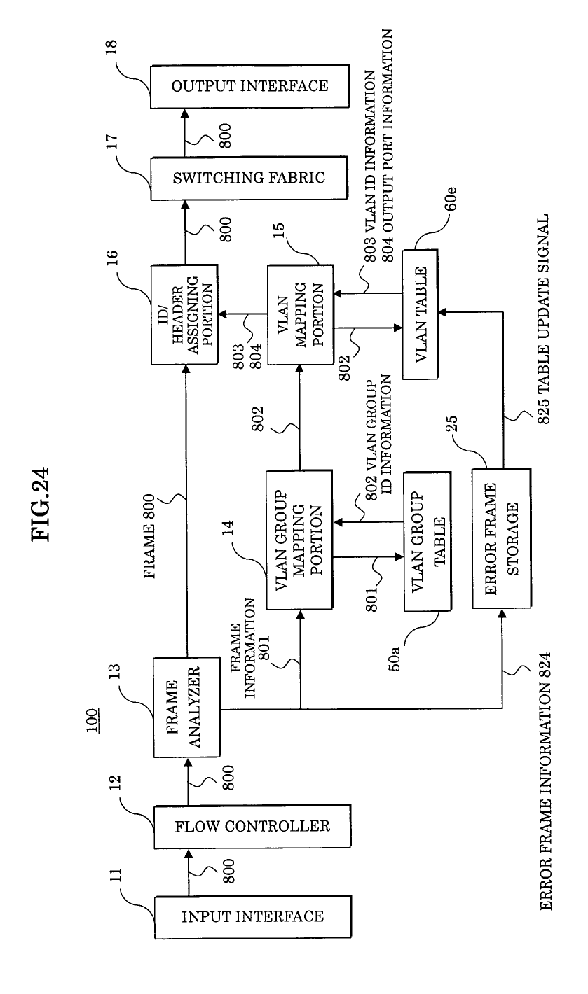

FIG. 24 shows an embodiment (9) of the LAN switch 100 of the present invention. This LAN switch is different from that of the embodiment (1) shown in FIG. 7 in that an error frame storage 25 is further provided, and the VLAN table 60e is the same as that of the embodiment (6) (see FIG. 20). It is to be noted that the VLAN group table 50a is the same as that shown in FIG. 8.

The storage 25 always monitors a port on the network side, i.e. traffics on each VLAN, and stores the number of frames including errors received within a preset fixed time on each VLAN.

Furthermore, the storage 25 provides a table update signal 825 to the VLAN table 60e, writes “1”, for each VLAN, in the best condition 70 associated with the VLAN whose reception rate of the frames including errors is the lowest within the same VLAN group, and writes “0” in the best condition 70 associated with other VLAN's.

The operation of the LAN switch 100 hereafter is the same as that of the embodiment (1).

Thus, the frame 800 is transferred by the VLAN whose condition is the best.

Embodiment (10): Notification of Line Fault by Alarm Transferring Frame

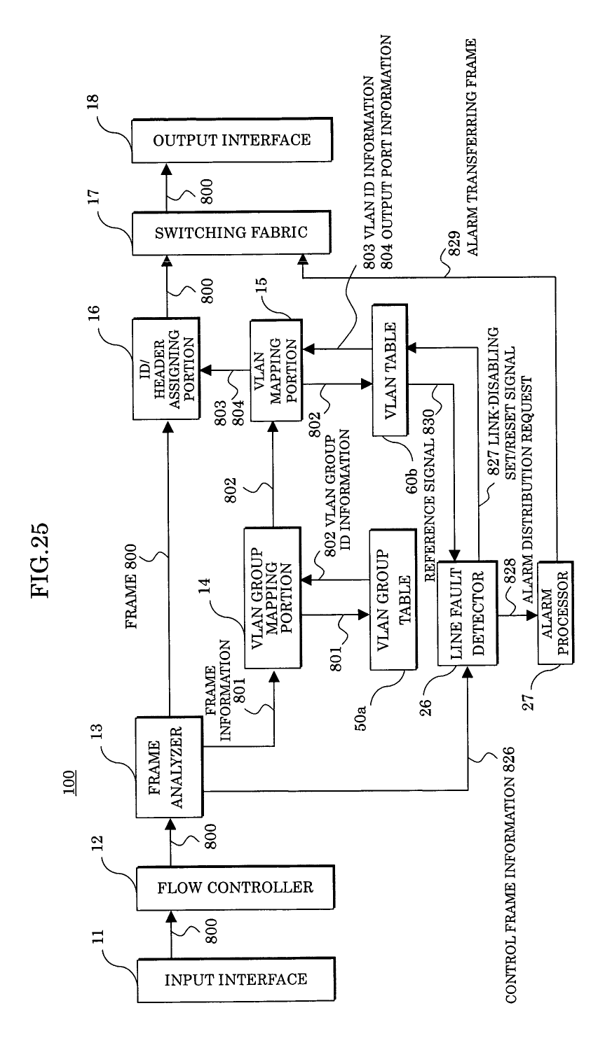

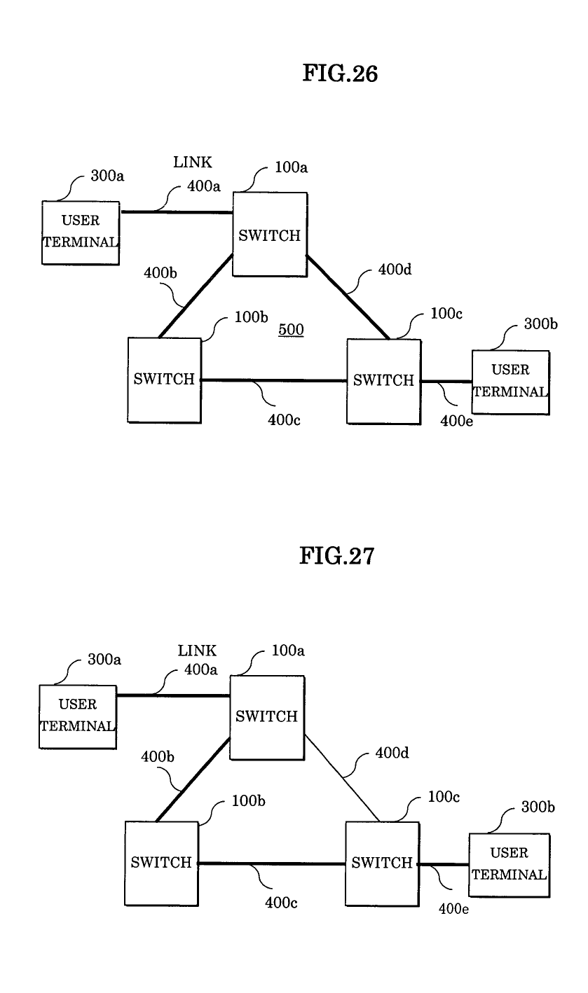

FIG. 25 shows an embodiment (10) of a LAN switch 100 according to the present invention. This LAN switch 100 is different from that of the embodiment (2) shown in FIG. 7 in that a line fault detector 26 is substituted for the line fault detector 19 and an alarm processor 27 is further provided.

It is to be noted that the VLAN group table 50a and the VLAN table 60b are respectively the same as those (see FIGS. 8 and 12) of the embodiment (2).

In operation, when detecting a line fault with control frame information 826 from the frame analyzer 13, the line fault detector 26 sets the link disable 67 associated with the entry of the VLAN using the line in which a fault has occurred, to “1” with a link-disabling set/reset signal 827.

Furthermore, the line fault detector 26 provides an alarm distribution request 828 including the ID of the concerned VLAN to the alarm processor 27, and requests a distribution of an alarm transferring frame 829 through the concerned LAN.

The alarm processor 27 broadcasts the alarm transferring frame 829 storing information that a line fault has occurred on the concerned VLAN through the concerned VLAN.

Also, when detecting a line fault recovery, the line fault detector 26 sets the link disable 67 associated with the concerned entry to “0” with the link-disabling set/reset signal 827.

When receiving the alarm transferring frame 829 from the LAN switch 100, the frame analyzer 13 notifies the fact to the line fault detector 26 with the control frame information 826.

The line fault detector 26 sets the link disable 67 associated with the VLAN in which a line fault has occurred written in the alarm transferring frame 829 to “1”.

Furthermore, the line fault detector 26, by looking up the VLAN table 60d with a referring signal 830, provides the alarm distribution request 828 requesting the distribution of the similar alarm transferring frame 829 through the other VLAN's composing the VLAN group same as the VLAN in which a line fault has occurred, to the alarm processor 27.

The alarm processor 27 broadcasts the alarm transferring frame 829 storing the information that a line fault has occurred on the concerned VLAN through a requested VLAN.

Thus, it becomes possible for all of the LAN switches composing the VLAN group to recognize a line fault.

The VLAN mapping portion 15, in the same way as the embodiment (2), maps the frame 800 to a VLAN whose link disable 67=“0” and rank 66 is the youngest order within the entries of the VLAN group. The operation hereafter is the same as that of the embodiment (1).

As described above, a LAN switching method and a LAN switch according to the present invention are arranged so that a plurality of paths are associated with a VLAN having a plurality of same members as components, and frames from the members are mapped to a predetermined path selected from among the paths. Therefore, it becomes possible to change a path which transmits frames, to distribute loads to paths, or to make a path redundant, as required.

Also, the LAN switching method and the LAN switch according to the present invention are arranged so that a plurality of different VLAN's are associated with a single group composed of a plurality of members, and frames from the members are mapped to a predetermined VLAN selected from among the VLAN's. Therefore, it becomes possible to change a VLAN which transmits frames, to distribute loads to VLAN's, or to make a predetermined VLAN redundant, as required. Namely, it becomes possible to an optimum path change, to distribute loads, or to make a path redundant.

Furthermore, the LAN switching method and the LAN switch according to the present invention are arranged so that information of a frame is associated with the group to which a member having transmitted the frame belongs, and the received frame is mapped to the group to which the member having transmitted the frame belongs, based on the information of the frame. Therefore, it becomes possible to map a VLAN to each group.

Furthermore, the LAN switching method and the LAN switch according to the present invention are arranged so that not a plurality of complicated protocols such as MPLS required for a control system but only protocols such as GARP and GVRP originally required for constructing a VLAN are used. Therefore, it becomes possible to easily develop devices and to easily perform services.

What we claim is:

1. A LAN switching method comprising:
a first step of establishing a plurality of VLAN's different from each other for a single group composed of a plurality of members, and
a second step of mapping frames from the members to a predetermined VLAN selected from among the VLAN's.

2. The LAN switching method as claimed in claim 1, further comprising, between the first and the second steps, a third step of mapping a received frame to the group to which a source member of the frame belongs, based on information of the frame received,
the second step mapping the frame to a predetermined VLAN selected from among a plurality of VLAN's of the group to which the frame has been mapped.

3. The LAN switching method as claimed in claim 1 wherein each path of the VLAN's comprises a physical or a logical loopless path.

4. A LAN switching method comprising:
a first step of associating a plurality of paths with a VLAN having a plurality of members as components, and
a second step of mapping frames from the members to a predetermined path selected from among the paths.

5. The LAN switching method as claimed in claim 4 wherein each path comprises a physical or a logical loopless path.

6. A LAN switch comprising:
a VLAN table for associating a plurality of different VLAN's with a single group composed of a plurality of members, and
a VLAN mapping portion for mapping frames from the members to a predetermined VLAN selected from the VLAN table.

7. A LAN switch comprising:
a VLAN table for associating a plurality of paths with a single VLAN having same members as components, and
a VLAN mapping portion for mapping frames from the members to a predetermined path selected from among the paths.

8. The LAN switch as claimed in claim 6 wherein each path of the VLAN's comprises a physical or a logical path.

9. The LAN switch as claimed in claim 7 wherein each path comprises a physical or a logical path.

10. The LAN switch as claimed in claim 8 or 9 wherein the path is loopless.

11. The LAN switch as claimed in claim 10 wherein the path is selected by a spanning tree protocol.

12. The LAN switch as claimed in claim 6, further comprising a VLAN group table for associating information of a frame with the group to which a source member of the frame belongs, and a VLAN group mapping portion for mapping a received frame to an associated group based on information of the frame by looking up the VLAN group table,
the VLAN mapping portion mapping the frame to a predetermined VLAN of the group selected from the VLAN table.

13. The LAN switch as claimed in claim 6, further comprising a line fault detector for detecting a line fault on each VLAN,
the VLAN mapping portion mapping the frame to a predetermined VLAN based on fault information from the line fault detector.

14. The LAN switch as claimed in claim 6 wherein the VLAN mapping portion sequentially maps the frame to each VLAN per frame.

15. The LAN switch as claimed in claim 6 wherein the VLAN mapping portion maps the frame to a VLAN different from a VLAN to which a frame has been mapped by a VLAN mapping portion of another LAN switch.

16. The LAN switch as claimed in claim 6, further comprising a frame classifier for classifying received frames to a plurality of classes,
the VLAN mapping portion mapping the frames to VLAN's associated with the classes.

17. The LAN switch as claimed in claim 6, further comprising a path monitor for monitoring a response on each VLAN,
the VLAN mapping portion mapping a frame, when the path monitor detects a VLAN having a lowered response, having been mapped to the VLAN to another VLAN.

18. The LAN switch as claimed in claim 6, further comprising a path selector for transmitting, when a frame having an IP packet capsuled is received, a ping frame to a member having a destination IP address of the IP packet, and for selecting an optimum VLAN, based on a response time of the transmission, from among a plurality of VLAN's associated with the concerned frame,
the VLAN mapping portion mapping the frame having the IP packet capsuled for the IP address to the optimum VLAN.

19. The LAN switch as claimed in claim 6, further comprising a pause frame storage for monitoring a number of pause frames received on each VLAN, and for notifying the VLAN mapping portion of a VLAN in which the number of pause frames within a predetermined time exceeds a specified value,
the VLAN mapping portion mapping a frame having been mapped to the VLAN to another VLAN.

20. The LAN switch as claimed in claim 6, further comprising an error frame storage for storing a number of frames including errors within a predetermined time on each VLAN, and for determining whether or not the number has reached a predetermined specified value,
the VLAN mapping portion mapping, based on the determination result, a frame having been mapped to the VLAN having reached the specified value to another VLAN.

21. The LAN switch as claimed in claim 13, further comprising an alarm processor for broadcasting an alarm transferring frame notifying a VLAN on which a fault has occurred through a designated VLAN, based on an alarm distribution request from the line fault detector,
the line fault detector providing the alarm processor with an alarm distribution request requesting to transmit the alarm transferring frame through a VLAN on which a fault has occurred when a line fault on the VLAN has been detected, and providing the alarm processor with an alarm distribution request requesting to transmit the alarm transferring frame through VLAN's except the VLAN on which a fault has occurred when an alarm transferring frame has been received from another LAN switch.
